(19) United States
(12) Patent Application Publication
(10) Pub. No.: US 2021/0209705 A1
(43) Pub. Date: Jul. 8, 2021

(54) System and Method for Managing and Operating an Agricultural-Origin-Product Manufacturing Supply Chain

(71) Applicant: ATP LABS LTD., Tel Aviv (IL)

(72) Inventors: ILAY ENGLARD, Tel Aviv (IL); NADAV HELFMAN, Binyamina (IL); ISHAI OREN, Tel Aviv (IL)

(21) Appl. No.: 16/754,167

(22) PCT Filed: Oct. 11, 2018
(86) PCT No.: PCT/IL2018/051098

§ 371 Date: Apr. 7, 2020

Related U.S. Application Data
(60) Provisional application No. 62/571,828, filed on Oct. 13, 2017.

(51) Int. Cl. G06Q 50/02; G06Q 10/06; G06Q 50/04; G06N 20/00

(52) U.S. Cl. CPC G06Q 50/02; G06N 20/00; G06Q 50/04; G06Q 10/06315

(57) ABSTRACT

System and method for managing and operating a closed-loop agricultural-origin-product manufacturing supply chain network. A method includes: collecting agricultural data from multiple sources relating to multiple growing-plots of crops; collecting environmental data relating to the multiple growing-plots; collecting operational data with regard to intended utilization of the crops at a manufacturing facility; identifying a particular growing-plot; correlating among agricultural data related to the particular growing-plot, and environmental data related to the particular growing-plot, and operational data related to intended utilization of crops from the particular growing-plot. The correlated data is analyzed for generating agricultural action recommendations to be performed at the particular growing-plot, as well as operational action recommendations to be performed at the manufacturing facility.

### CROSS-REFERENCE TO RELATED APPLICATIONS

This patent application claims priority and benefit from United States provisional patent application number U.S. 62/571,828, filed on Oct. 13, 2017, which is hereby incorporated by reference in its entirety.

### FIELD

The present invention is related to agriculture management systems.

### BACKGROUND

Agriculture is the cultivation of land and breeding of animals and plants to provide food, fiber, medicinal plants, and other products intended to sustain and enhance life. Agriculture has been a key development in the rise of human civilization. The history of agriculture dates back thousands of years, as people gathered wild grains, planted them, and domesticated animals such as sheep and cows.

### SUMMARY

The present invention provides systems and methods for improving, optimizing, managing and/or operating a agricultural-origin-product manufacturing supply chain (and particularly, a food and beverage supply chain). For example, a system and a method collect, store, analyze, process, and/or otherwise integrate current and/or historical and/or predicted and/or estimated operational data/information, environmental data, and agricultural data, in order to assist food manufacturers to control risk and uncertainty of their manufacturing and business processes related to procurement of agriculture produce, and to assist farmers or growers or suppliers of agriculture produce to increase the yield of (or, to actualize the full potential out of) the fluctuating agriculture environment, and/or to increase of the probability of achieving crop metric goals regarding quality factors, quantity factors, yield, timing, and/or cost. The system interfaces with different personas or entities in the network as needed, and facilitates their on-going collaboration. The system generates synergized information and/or new insights, which are utilized for Business Intelligence (BI), analytics, Machine Learning (ML), Artificial Intelligence (AI), and/or other types of data processing methods.

For example, a method includes: collecting, obtaining, and/or automatically integrating agricultural data from multiple sources relating to multiple growing-plots of crops; collecting, obtaining and/or integrating environmental data relating to the multiple growing-plots; collecting, obtaining, and/or integrating in-season samples and observations of crops collecting operational data with regard to intended utilization of the crops at a manufacturing facility; identifying a particular growing-plot; correlating among agricultural data related to the particular growing-plot, and environmental data related to the particular growing-plot, and operational data related to intended utilization of crops from the particular growing-plot. The correlated and/or integrated data is analyzed, using learning models and/or in view of agricultural protocols and/or operational protocols, and/or by utilizing Machine Learning (ML) and/or Artificial Intelligence (AI) processes, for generating agricultural action recommendations and insights to be performed or further utilized at the particular growing-plot, as well as operational and business (e.g., buying/selling, advance purchase, advance sale) action recommendations to be performed at the manufacturing facility or by the manufacturer.

### BRIEF DESCRIPTION OF THE DRAWINGS

FIG. 1A is a schematic block-diagram illustration of a system, in accordance with some demonstrative embodiments of the present invention.

FIG. 1B is a schematic block-diagram illustration of a system, in accordance with some demonstrative embodiments of the present invention.

FIG. 1C is an enlarged version of the left-side (the left half) of FIG. 1B.

FIG. 1D is an enlarged version of the right-side (the right half) of FIG. 1B.

FIG. 2 is a diagram demonstrating communications and relations among entities and data-items using Unified Modeling Langue (UML) notation, in accordance with some demonstrative embodiments of the present invention.

### DETAILED DESCRIPTION OF SOME DEMONSTRATIVE EMBODIMENTS

The Applicants have realized that some agricultural systems, and particularly systems utilized by agricultural-origin-product manufactures (e.g., wineries, potato products, food and beverage companies in general, as well as fresh food retailers or vendors or distributors), may have strict requirements with regard to quality, quantity, and supply timing and cost. In the food industry, the cost of raw ingredients is essential for profit and growth. The Applicants have realized that an agriculture crop is highly affected by the environment, the plant varieties used, as well as by the cultivation process and by performance or non-performance of certain operations (e.g., irrigation, fertilization, pruning) and the particular timing and attributes of such operations (e.g., irrigation quantity and timing, fertilization quantity and timing), resulting in high variance in the supply, which in turn translates to an associated business risk which should be prevented or mitigated via technological means.

The Applicants have realized that in order mitigate such risk, agricultural-origin-product manufactures may utilize a “vertically integrated supply chain network” operations model. For example, prior to the growing season, the manufacturer contracts with multiple farmers; whereas during the growing seasons, the manufacturer supervises and monitors the growing process and the growing progress; such as, via an “Agriculture Department” at the manufacturer. The Applicants have realized that conventional systems lack the utilization of predictive information and predictive processes, to quantify and act upon real-time and future fluctuations in crop performance.

The Applicants have realized that an agricultural management system may collect, analyze and integrate field observations, crop samples, agricultural expertise, understanding of manufacturing operational needs, and information from several data silos or data sources; for example, past weather data and/or current weather data and/or predicted weather data; images obtained from imagery and mapping services or sources; data sensed or captured or measured by field sensors or measurement units or controllers; as well as data from operational information systems such as Enterprise Resource Planning (ERP) systems, material requirements planning, Supply Chain Management systems, or the like. The collected and analyzed data may relate to a “plot identifier” (e.g., an identifier of an area of land in which a particular crop grows); and may optionally be associated with the geographical location, the yield, the variety, the quantity, and/or quality test results (e.g., carried out on delivery batches) and cost. For example, for wine grapes, these results may include Brix (sugar level metric), pH and TA; whereas for potatoes, these results may include percentage of dry material, size and sugar levels. The system and method of the present invention may empower the manufacturer, and well as the individual growers in the supply chain, to generate higher yield and to improve their outcomes and meet industry demand.

The Applicants have realized that some conventional systems may track the supplied crop starting from the point that it is delivered to the “factory gate” of the manufacturer; but fail to link that data with the previous or full environmental data and agricultural data related to that particular batch that was delivered to the factory; thereby preventing conventional systems from generating useful insights which can be utilized for increasing yield, meeting business goals, meeting supply timing requirements and supply quantity requirements and/or supply quality requirements, or otherwise mitigating business risks.

In accordance with the present invention, a closed-loop agricultural-origin-product manufacturing supply chain network includes a manufacturer (or retailer, vendor, distributor, or other vending entity or distribution entity) and multiple farmers that were contracted prior to the growing season to grow crops based on the manufacturer specification. The system may also include entities or operations which buy or sell crops, for example, in advance, pre-season, in the spot market, in a commodities market or exchange, or the like. Optionally, the manufacturer's supplier(s) may be an aggregator that represents or that comprises a group of individual farmers. The manufacturer plans, produces, and ships multiple products that originated from a supplier of agricultural crop(s); and the manufacturing process may be highly affected by the bio-chemical attributes, physical attributes, quality attributes, quantity attributes, yield attributes and/or timing attributes of the crop.

Some embodiments may collect and analyze data from one or more data repositories; for example: (a) Operational information system or repository, Enterprise Resource Planning (ERP) system or repository, Suppliers Relationship Management (SRM) system or repository, Supply Chain Management (SCM) system or repository, or other operational information systems or repositories, which may be operated by the manufacturer and/or by third parties; wherein the scope of these systems starts at or even before the delivery of the crop to the factory gate, and includes the “in season” (or “in growing season”) context or data or attributes. (b) Data services, such as current and/or historical and/or predicted weather data, satellite images, soil chemistry data, land topography data. (c) Measurements and records and sensed data from the field during the season, such as, lab tests, crop features (e.g., fruit size, color, quantity), log or records of cultivation actions, or the like. (d) Data from sensors, measurement units, and controllers; such as, irrigation and fertilization controllers that produce logs, sensors for humidity, temperature, precipitation (e.g., rain, snow, dew), or other sensors or controllers that are deployed in the field.

The present invention operates to assist agricultural-origin-product manufacturing in the business processes of purchasing crops (including, but not limited to, purchasing crops that are yet to be harvested, or crops whose growth has not yet been completed; including pre-season purchases, in-season purchases, and post-season purchases) and monitoring the growing seasons in correlation with the manufacturing goals; and further assists farmers in the network by making useful information become easily accessible, and improving the communication between or among the farmers, manufacturer, and retailers or distributors.

A demonstrative embodiment may comprise and utilize the following components: (a) a Data Integration Unit, which integrates the related data mentioned above, including operations of fetching the data, cleansing, integrating, enrichment and further processing the data, as well as generating associations and links among data-items that pertain to the same growing-plot or growing-area and that were obtained from multiple different data-sources; (b) a Domain Modeling Unit, to store representations of cultivation protocols, operational costs, and other modeled data; (c) a Data Warehouse Unit or Repository, such that the processed data is stored and is represented as a fully integrated data schema in which the operational data, agricultural data and environmental data are fully correlated with each other; and utilizing linking or correlating based on Time attributes, Spatial attributes, Crop attributes, Soil attributes, weather attributes, plant features, yield attributes (e.g., plant quality, plant quantity, plant size, plant color), or the like. (d) a Business Intelligence (BI) unit, to generate analytics and reports. (e) a Machine Learning (ML) and/or Artificial Intelligence (AI) Unit, to analyze the data and to identify patterns or repeated patterns or repeating patterns, and/or to identify abnormalities or irregularities or anomalies that may require an alert notification to perform mitigation operations (e.g., agricultural mitigation operations, cultivation operations, manufacturing mitigation operations, business mitigation operations such as ordering or purchasing or selling crops), and may generate Predictions, Farming recommendations, Operational recommendations, business decision support recommendations, or other insights. (f) a Return on Investment (ROI) Estimation unit, to generate metrics analysis with regard to current performance and/or with regard to “what if” scenarios or sets of conditions. (g) a Business Processes and User Experience Unit, to manage and provide a user interface for the manufacturer and/or for the farmers/growers, and/or to present to them recommendations or alerts or notifications or reports, and/or to receive from them additional updates or inputs or decisions or commands.

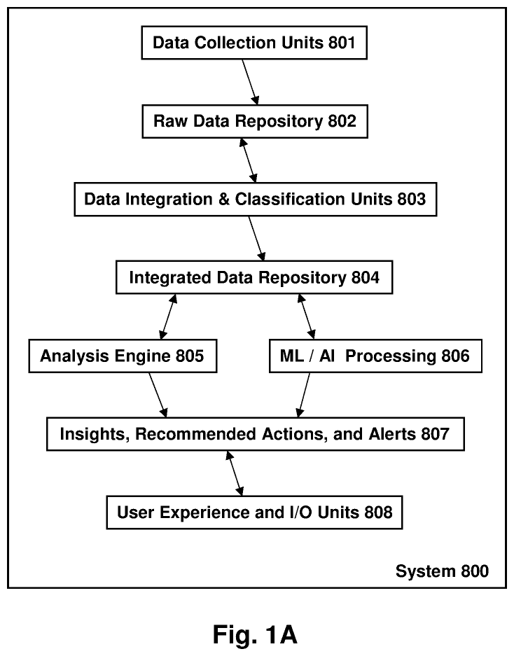

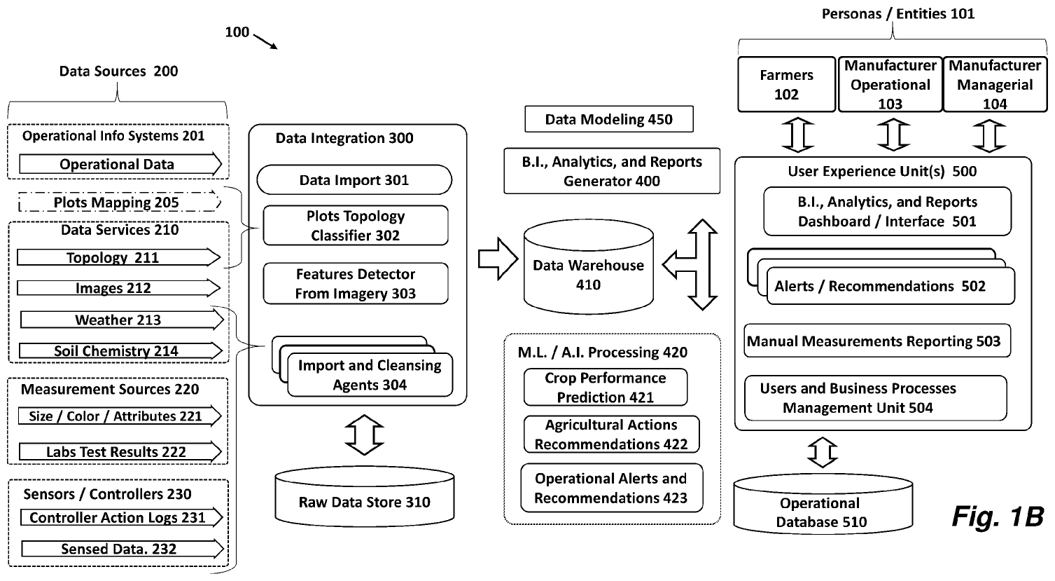

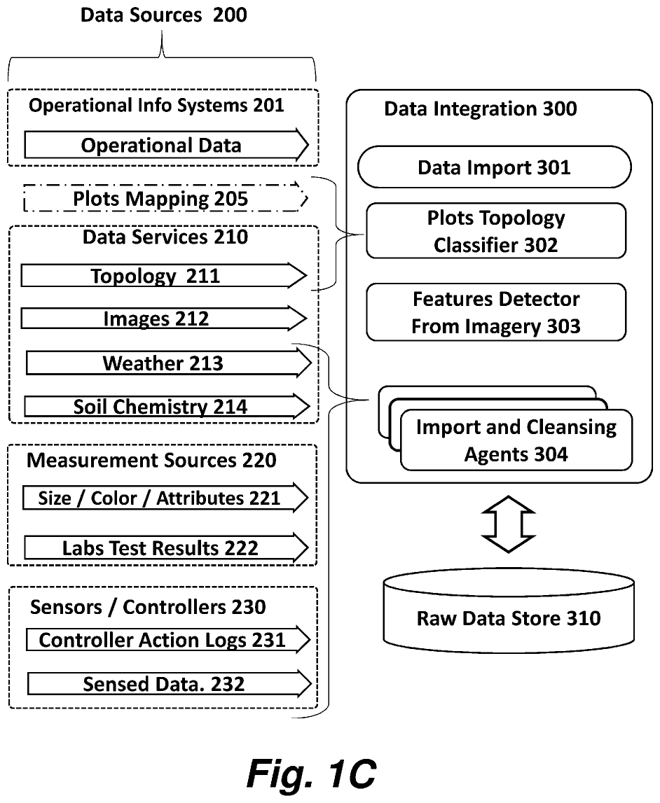

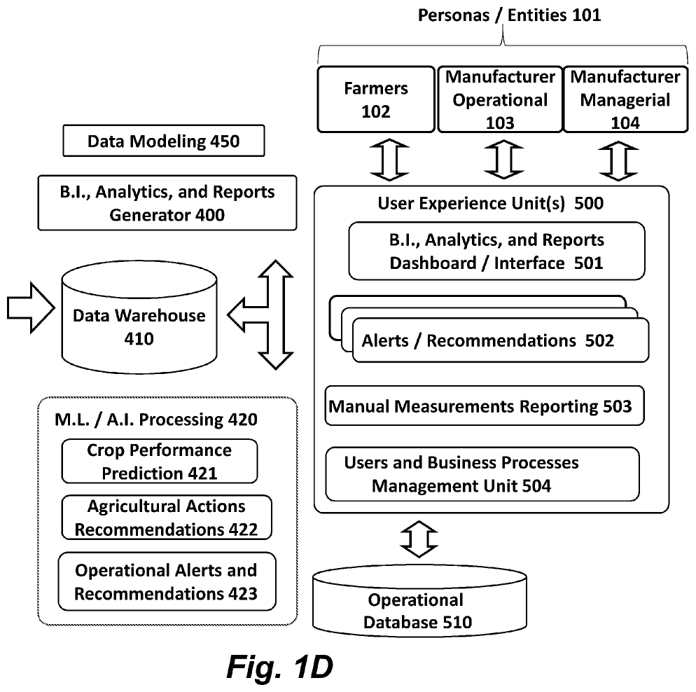

Reference is made to FIG. 1A, which is a schematic block-diagram illustration of a system 800, in accordance with some demonstrative embodiments of the present invention. Data Collection Units 801 collect or obtain or pull data from sensors, controllers, data services, measurement sources, operational information systems, and other data sources. The data is stored in a Raw Data Repository 802. Data Integration & Classification Units 803 perform integration and classification of the raw data, and particularly, perform correlation or association among data-items that were obtained from different data sources and that are determined to be related to the same growing-area or growing-plot. The integrated and post-classification data is stored in an Integrated Data Repository 804. An Analysis Engine 805 analyzes the integrated data, based on pre-defined Models and Protocols (e.g., agricultural models and protocols, operational models and protocols, environmental models and protocols), in conjunction with a Machine Learning (ML)/Artificial Intelligence (AI) Processing Unit 806; and generates insights, proposed or recommended actions, and alerts 807. User Experience and Input/Output (I/O) Units 808 enable users of the system (e.g., farmers; manufacturer's agriculture unit; manufacturer's managerial unit; manufacturer's operational unit) to interact with the system, to submit queries and obtain insights and proposed actions.

Reference is made to FIG. 1B, which is a schematic block-diagram illustration of a system 100, in accordance with some demonstrative embodiments of the present invention. FIG. 1B may be a specific implementation of system 800 of FIG. 1A. For purposes of clarity, FIG. 1C is an enlarged version of the left-side (left half) of FIG. 1B; and FIG. 1D is an enlarged version of the right-side (right half) of FIG. 1B.

System 100 comprises or utilizes multiple data sources 200; performs data integration, classification and/or correlation on the data via Data Integration units 300, relative to a raw data store 300, and outputs correlated or integrated or classified data which is stored in a correlated Data Warehouse 410; and the correlated data is further analyzed by BI, analytics and reports generation units 400, as well as ML and AI processing units 420. Multiple personas or entities 101-103 may access or interact with the system and/or may provide data and/or may obtain data, via a User Experience module 500, which is associated with an Operational Database 510.

Data collection and integration is performed by obtaining or fetching data from multiple data sources 200. For example, operational information systems 201 provide operational data; one or more data services 210 (e.g., third party data services, or publicly available data services) may provide topology data 211, images 212 (e.g., satellite images, other images), weather data 213, soil chemistry data 214, and plot mapping data 205. Other data sources may be used; for example, mapping data, geo-spatial data, geographic data, data from a Geographic Information System (GIS), data describing or indicating terrestrial attributes or topography or elevation, or the like. Additionally, measurement units 220 or measurement processes (e g, manual and/or automated and/or semi-automated) may provide measurements and reports from the growing field or plot, such as size or color or other fruit attributes or plant attributes 221, and labs test results 222. Field sensors and associated controllers 230 provide sensed data 232, as well as logs of actions 231 performed (or commanded) by controllers (e.g., irrigation operations log, fertilization operations log)

Data Integration Unit 300 operates to collect, verify, clean (or cleanse) and process the data while integrating the data from the different data sources; and particularly while linking or cross-linking or correlating or associating between data-items provided between different data-sources yet relating to the same plot or field or plant or growing-bed. A data import unit 301 operates to import, fetch, download, copy, or otherwise obtain the data from the relevant data source(s).

The data integration, data classification, and data cross-linking or data association or data correlation may be based on (or, may utilize) plot mapping information 205. A “growing plot” may be a specific land area dedicated to a single agricultural raw material in a specific season. A growing plot in the operational information system, is mapped into the bounding curve of its location on Earth. Such mapping may be performed manually, or in an automated manner or semi-automated manner, or may be facilitated by maps and/or via user experience, or may be extracted from regional mapping databases, and/or by utilizing a Geographic Information System (GIS) or data from similar systems. In some embodiments, for example, a farmer may provide a map representation of a field, with added rectangles or boxes indicating particular growing plots, and/or with indicia (e.g., text or numbers) of the plant or crop or fruit that is grown in each plot. In another embodiment, for example, an aerial image or a satellite image or a flying drone image or a street-view image or other image, provided by the farmer and/or by other sources, may show a particular plot having a particular crop that can be identified or recognized via computer vision (e.g., corn; banana; or the like), or may show a sign placed in the field (e.g., “Strawberry Field #6”) which can be processed via Optical Character Recognition (OCR) from an image of that plot; and such images may be accompanied with GPS data or other location data that indicate the geographic location in which the image was taken. In other embodiments, the system may automatically process a pre-provided list which indicates that a particular plot (e.g., identified via longitude and latitude parameters, or via other identifiers) grows a particular crop of plant or fruit. Other plot mapping sources or methods may be used such as a Geographic Information System (GIS) or other systems.

Data sources which have the characteristics of a numerical metric over time, such as Operational Data, weather, soil chemistry, manual observations, lab tests, controller logs, sensor data, or the like, may each be collected and processed by a dedicated data import and cleansing agent 304. This agent follows the plots mapping information to retrieve the corresponding information from the data source; and then stores a local copy of the information source data structure in the raw data store 310, to enable further refined processing for correctness and/or validations. In addition, it extracts the values of interest, checks their integrity, and ingests them into the data warehouse (410).

The earth topology data source 211 may be associated with a dedicated processing agent, such as a plots topology classifier 302. It uses the mapping data 205 which maps growing plots to land, in order to extract an elevation map of that plot. From this elevation map, features such as aspect and slope of an approximate plane that represents the plot, are extracted. These features are stored in the data warehouse 410, related to crop performance metrics and/or to other crop attributes of that particular growing bed. For example, in wine grapes, this enables to correlate the hill side aspect on which the plot is planted, to the wine grapes performance metrics at harvest time (e.g., Brix, PH, and TA parameters).

Images 212 are processed by a dedicated agent, such as a features detector 303 based on imagery and image analysis. For example, images over time which are targeting each growing plot, in multiple wave-lengths as applicable, are retrieved from the relevant data source 212. For each image, numerical and categorical features are calculated using ML algorithms and stored in the data warehouse 410. For example, using a series of satellite images of the plot over time, while clipping or cropping or trimming or otherwise isolating the area-of-interest that matches the bounding curve or the boundaries of a particular plot, the system may calculate the chances or the probability of having a crop epidemic in that particular plot. As another example, the system may utilize Normalized Difference Vegetation Index (NDVI) data, such as remotely-sensed or remotely-estimated NDVI values, in order to infer or generate insights about certain agricultural operations performed or certain agricultural events that occurred, such as in-season pruning and harvesting operations. These inferences as well as other suitable insights or inferences may then feed into other AI models that compute and simulate or emulate how the timing of these operations impact crop performance or crop attributes at the end of the growing season, as well as other business metrics such as, for example, crop waste, predicted profitability, and/or other parameters.

The operational data may include data and attributes of delivery events of crops or plants or fruit from the field, through a transportation network to the manufacturer's facility (e.g., factory gate, factory floor, or storage). Each delivery event may include weight and/or volume data, origin identification (grower identifier, growing plot identifier), date and or time of the delivery event and of the actual harvest; and/or other data-items, quality attributes and/or metrics. For example, for wine grapes, the metrics may include Brix, pH, TA, color, phenolics. For industry targeted potatoes, the metrics may include: variety, Percentage of dry matter, Dextrose level and size. The data for other crops may include quality and quantity metrics or attributes or characteristics, such as moisture level, protein level, sugar level, acidity level, size, color, or any other attribute that may be important or relevant or useful (directly or indirectly) for maximizing manufacturing value and/or for generating decisions or recommendation or insights.

A modeling unit 450 may perform real-time and/or offline data modeling, and may utilize such modeling to correlate between data from various sources. The modeling unit is shown as a separate unit, but it may be implemented as part of the data integration unit(s) 300, or may be implemented as part of the ML/AI unit(s) 450; or may be implemented by using other modeling criteria, for example, a pre-defined list of rules or conditions or threshold-values or ranges of threshold-values, lists of classification parameters or classification rules, or the like. The modeling unit 450 may use manufacturing models to correlate between (i) raw-material crop metrics, and (ii) manufacturing metrics and/or target product(s) metrics. For example, with regard to potatoes, the model correlates between (i) the percentage of dry material and/or the factory potato intake, and (ii) the overall cost of frying potato chips. For wine grapes, the model includes the overall estimated revenues for different blends and series of wines, with correlation to different combination of wine grape crop metrics.

The modeling unit 450 of the system may include and/or may utilize agricultural models and/or their representations; for example, indicating or modeling attributes or characteristics for the different varieties of crops, and well as models of cultivation protocols and agricultural operations or actions that are intended or planned to be performed in order to achieve high yield and/or high-quality of produce; as well as a cultivation protocol model which includes a sequence of phenological phases, required conditions, and possible actions and decisions for each of them, optionally utilizing threshold values or threshold ranges-of-values and conditional operations (e.g., if attribute X has a value greater than threshold value Y, then perform cultivation operation Z).

The Data Warehouse 410 is a database or repository that integrates or associates or correlates or links or creates a relation among the various operational, environmental, and agricultural data-items and/or information sources, in a manner that exposes the correlation between data from the different sources, and particularly with regard to a certain growing-plot or with regard to a certain batch or group of growing-plots; in contrast with conventional systems in which each data source along the food supply chain is a separate and isolated “data silo” that does not relate to data in other, isolated, data silos.

The BI, analytics, and reports generation unit(s) 400, in association with the Business Intelligence (BI), analytics, and reports dashboard/interface 501 (which is implemented by the User Experience Units 500), generate and output BI insights, analytics insights, and reports; and particularly, such insights that correlate, link and/or otherwise associate or integrate among supply chain business and operational attributes, environmental attributes, agricultural attributes, agricultural operations, cultivation operations, cultivation protocol(s), and/or manufacturing process(es); and further makes the operational environmental and agricultural data warehouse 410 accessible for querying, for slicing or dividing of the stored information into data-slices or data categories or data classes and for “dicing” or analyzing or otherwise processing the categorized data for extraction of insights. For example, a query may correlate between (i) the cost of a particular variety (or type) of grapes, and (ii) the weather profile during the growing season at the particular growing-plot in which this particular variety of grape is grown; and may generate a decision or a recommendation which wine grape plots should be (or, should not be) selected for each wine manufacturing program; and may optionally generate a determination that the grape yield from a particular growing-plot (or, from a particular batch or group of growing-plots) should be directed to manufacturing of a first type of wine and not to a second type of wine, or should be directed to manufacturing of grape juice rather than wine, or the like. In another example, for potatoes, the harvest operation (e.g., as extracted from the operational information system origin delivery event), may correlate with (or, may indicate towards) the quality attributes of potato (dry matter, dextrose, size) and may further lead to (or may enable the system to generate) determinations or predictions or recommendations with regard to the quality and/or up-stream manufacturing program that such potatoes may be used for (e.g., mass market sales; high-end consumer sales or restaurants sales; production of French fries products; production of other potato-based or potato-including products; or the like).

Machine Learning (ML)/Artificial Intelligence (AI) processing units 420 may analyze data organized in the data warehouse 410; and may perform training, resolving, and periodic refining (or iterative refining or fine-tuning of updating or modifications) of ML/AI models in order to generate ML-based or AI-based insights, such as, ML/AI based estimations, recommendations, predictions, determinations, required operations, optional operations, business actions, business operations (including, but not limited to, purchase operations, sale operations, channeling of a particular inventory towards manufacturing of a particular product), or the like.

For example, a Crop Performance Prediction Unit 421 of the ML/AI processing units 420 may analyze the integrated data and may generate predictions or estimations for the metrics of a crop-of-interest. In a first example, it may generate prediction(s) during the growing season with regard to the optimal or suggested or required harvest time metrics (e.g., beginning and/or ending of harvest), based on analysis of overall past seasons and historical data, current data, domain knowledge and pre-defined rules and cultivation protocols, current season weather and imagery information (until prediction date), weather forecast, comparison to historical weather data and/or historical imagery from past growing seasons, and one or more pre-defined manufacturing goals or manufacturing targets or manufacturing processes that are linked to this particular crop-of-interest (e.g., a pre-defined target to utilize grapes for a first type of wine if a first set of conditions is met, or to utilize them for a second type of wine or for a different product such as grape juice if another set of conditions is met).

In another example, the Crop Performance Prediction Unit 421 may perform estimation of in-season metrics based on samples from past and/or current growing seasons, as well as domain knowledge, current in-season data such as weather and imagery information and/or other attributes or data as mentioned above. Demonstrative examples of such in-season metrics which may be estimated or predicted are: Leaf Water Content chemical attributes (e.g., sugar level), size, color, weight.

In yet another example, the Crop Performance Prediction Unit 421 may perform prediction, before or during the growing season, with regard to dates and change-rates for plant phenological phases and transition time (e.g., flowering, ripening level), based on observations from past seasons of similar crop varieties, domain knowledge, current season weather, imagery information, weather forecast, and other attributes mentioned above. As an example for phenological phases prediction in wine grapes, the Crop Performance Prediction Unit 421 may identify a pattern that indicates that the winter was dry (e.g., beyond a pre-defined threshold value of dryness, such as if during a certain month the aggregate precipitation was lower than a pre-defined value), and may therefore determine that the first irrigation of the season should be performed before the Budburst phase; based on a prediction that a heat wave before the flowering phase may cause loss of a significant part of the yield, unless properly migrated with additional irrigation. Similarly, the Crop Performance Prediction Unit 421 may determine that in order to achieve specific quality standard, after the flowering and before the Veraison phase, a thinning-out action is required; and therefore, Veraison date prediction by the Crop Performance Prediction Unit 421 enables to optimally schedule this field activity. In another example for wine grapes, the Crop Performance Prediction Unit 421 may determine that spraying for Powering mildew should take place before the beginning of fruits development. For potatoes, the Crop Performance Prediction Unit 421 may predict the phenological phase in which potatoes in the ground are fully developed but have a thin skin which thus enables the system to schedule the optimal timing for Vine Killing activity.

An Agricultural Actions Recommendations Generator 422 may analyze the data generate recommendations for agricultural actions and/or agricultural decisions. For each growing season during the different phases of the cycle, the farmer 102, optionally in coordination with the manufacturer operational unit 103, may receive generated insights indicating agricultural decisions and the corresponding actions that should be performed. For example, for wine grapes, the farmer needs to decide regarding per plot timing of post winter first irrigation, as well as per plot scheduling and priority of pruning (which is a labor-intensive operation) based on the estimated effect on end of season revenues. For potatoes, the decisions are regarding operations of Planting, Vine Killing, Harvest date, as well as per plot recommendations of weekly irrigation and fertilization quantities during the course of the growing season

An Operational Alerts and Recommendations Generator 423 analyzes the data and generates recommendations for operational decisions and required actions. For each growing cycle, the operational/agricultural units 103 as well as the managerial unit 104 of the manufacturer utilizes insights generated by this generator 423 to make decisions and take corresponding actions. Some decisions are taken before the growing cycle; and some are taken for the different phases of the growing season. For example, for wine grapes, such decisions may include: schedule and order of vineyard harvest, among the overall wine grape plots of the different growers, based on the estimated values for Volume, sugar level (Brix) and Acidity (pH and TA); target blends and series; vineyard and transportation capacity; purchasing or selling grapes to meet manufacturing goals, or the like. For potatoes such decisions may include: elect growers and plant the varieties mix for each grower and/or for each growing plot for the next growing season; schedule and order of harvest for potatoes, based on quantity, quality and production requirements, as well as potato storehouse stock qualities, factory capacity, and target products need; order or purchase potatoes from suppliers or growers abroad or from the spot market, or growers that are external to the system, during the growing season, to compensate in advance for a crop which is expected to be poor performing (e.g., low quality, low yield); Return on Investment (ROI) estimations and decisions derived from it; or the like.

Based on the current and historical data in the data warehouse 411, and based on a manufacturing model, an agricultural model, the generated agricultural recommendations, and the generated operational recommendations, a ROI estimation/modeling unit (e.g., which may be part of the BI, Analytics and Reports Generator 400) estimates the business benefit of implementing current, past and/or or future recommendations which are generated by the system. This enables the system and the user to quantify the overall impact of supply chain management decisions on overall cost and efficiency. Furthermore, the value of accepting recommendations may also have logistics or financial aspects or benefits.

The user experience unit(s) 500 is a sub-system which interacts with personas or entities 101, such as the farmer(s) 102, the manufacturer operational unit 103 or agriculture procurement & sourcing department, and the manufacturer managerial unit 104; and enables such entities to request, obtain and consume insights, dashboard-based analytics, and reports via a real-time Analytics and Reports Dashboard/Interface 501; to receive alerts and recommendations 502 as well as other notifications and action proposals, which may be organized as textual items and/or graphical items, and may optionally be organized or sorted or ordered as a list or as a feed which may automatically be updated, refreshed, sorted or filtered. A manual measurement reporting unit 503 allows such user or entity to input, provide, or import data into the system, manually or in an automated or semi-automated manner. The input or import of data may optionally be performed or facilitated using integrated equipment, for example, a data collector component that periodically collects data from field sensors, converts them into a suitable/compatible format, and sends the sensed and formatted data for storage in the data warehouse and further processing.

The user experience and other functions may be provided or delivered to users via web-pages and/or via a dedicated application or mobile application or “app” or via a web browser, for each applicable device which may include a mobile device, a tablet, a laptop computer, a desktop computer, or other electronic devices. The overall available options are organized based on the persona or entities roles and business processes/activities/possible decisions (e.g., via Users and Business Processes Management Unit 504), which are currently relevant based on the growing season of interest (e.g., next season planning; in-season analysis; post-season analysis). The backend processing of the user experience unit(s) 500 may optionally utilize an Operational Database 510 for persistency.

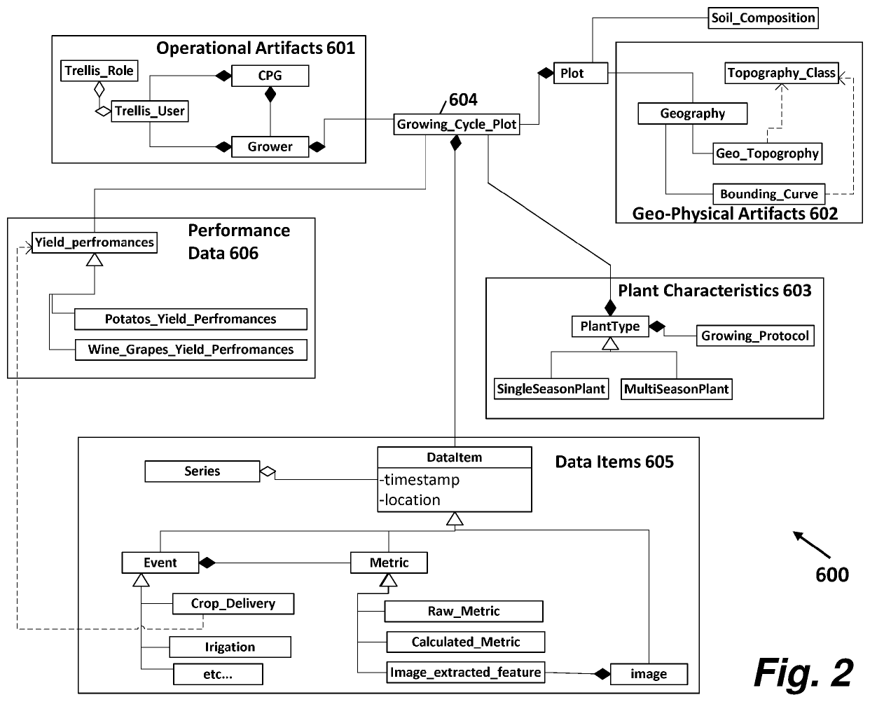

Reference is made to FIG. 2, which is a diagram 600 demonstrating communications and relations among entities and data-items using Unified Modeling Langue (UML) notation, in accordance with some demonstrative embodiments of the present invention. The diagram may assist engineers in constructing a database scheme for an implementation of the system.

For example, operational artifacts 601 are correlated into (or with) geophysical artifacts 602 and plant characteristics 603, using a growing cycle plot entity 604. To this entity, the system further correlates all the other data items 600, such as performance data 606 reflecting attributes and characteristics of the crops, as well as metrics, events, images, sensed data, measured data, or the like. Individual data items may further relate to a Series of items over time.

Referring back to FIG. 1A (or to FIG. 1B), a non-limiting example of the system's operations is described herein. For example, a Data Collector Unit collects data (e.g., as discrete data-items or measurement values, or as a continuous stream of data) from multiple sources; for example, ERP Data, geo-spatial data, topology data, historical and real-time weather data, predicted weather data, images and/or video from cameras or imagers, soil chemistry data, mapping data, plot mapping data, growing bed mapping data, crop (plant, fruit, produce) attributes/characteristics data (e.g., collected manually or in an automated or semi-automated manner; such as, crop size, quantity, color, quality, lab test results of crops, or the like), geo-spatial data (e.g., elevation or altitude of vertical height of a growing plot; slanting or spatial orientation a growing plot; spatial direction of an earth curvature or hill, such as, being slanted southbound or northbound, or the like), sensed data collected or read from sensors and/or controllers (e.g., temperature, radiation, precipitation, data, humidity data, soil moisture), agricultural operations and agricultural events data as collected from sensors or controller (e.g., irrigation data from an irrigation controller, including the amount or volume of irrigation performed, and optionally including other irrigation attributes or data-items, such as the timing of irrigation events; data about fertilization or cultivation operations performed, including timing and particular attributes of the operations; data about field level activities such as spraying, scouting, pruning or harvesting operations performed; or the like), operational data and manufacturing related data (e.g., data indicating that a particular plot or growing bed is associated with a particular manufacturing process or manufacturing goal that is intended to be performed on the yield or the produce of that particular plot or growing bed; or data indicating that the yield of a particular growing bed is intended to be utilized for one of out multiple alternative uses or products that will be determined by the system based on the progress of the cultivation and/or based on the ongoing or final attributes of the produced crop and/or based on supply and demand data and/or based on cost-related or price-related data), data from logs or reports (e.g., of sensors, of controllers, of manufacturing equipment, of growing equipment, of cultivation equipment), models and protocols (e.g., varieties, cultivars, agricultural models, agricultural protocols, cultivation models, cultivation protocols, operational models, operational protocols, manufacturing models, manufacturing protocols), data received from sources based on manual input or manual entry (e.g., by the farmer or grower, by the manufacturer), and/or other types of data.

Optionally, a Data Import & Conversion Unit may perform operations of data importation from local, remote and/or external data sources, as well as conversion or transformation of such data from a first format (or unit) to a second format (or unit); and may optionally perform data normalization on one or more data-items or streams of data, or data pruning (e.g., discarding an irregular data-item that is estimated to be an erroneous reading that does not match previous readings and/or subsequent readings), or the like.

The collected and optionally re-formatted/converted data, is stored and integrated into an Integrative Data Repository. For example, a Data Correlation & Association Unit may determine and may store links, correlations, and associations among data-items or data-streams; and may optionally filter, sort, prune, crop, or isolate a first particular data-item or data-stream segment which correlates to a second particular data-item or data-stream segment.

The Data Correlation & Association Unit may utilize one or more identifiers or tags in order to determine an association or correlations among data-items or data-stream segments. For example, a particular growing bed or growing plot of a particular crop or plant or produce, may be tagged or identified in the field by using a physical sign or tag (e.g., barcode, label, QR code, textual indicia such as “Potato Field #62”). Such sign or tag may later appear in an image or video, and may be identified or recognized using computer vision algorithms or via Optical Character Recognition (OCR) or via a scanner module that recognizes and reads barcodes or QR code; and that particular image may then be tagged or identified as correlating to that particular growing plot or bed (e.g., Grapes Bed #62). That particular image may further include EXIF information or other location-based information, which indicate the geographic or geo-spatial location in which the image was captured; thereby allowing the system to further associate or correlate between (i) that image, and (ii) that growing bed or plot, and (iii) a geographic location (e.g., indicated via latitude and longitude coordinates). This correlation may further enable the system to pull the particular weather data (e.g., historic weather data, current weather data, predicted weather data) that is associated with that geographic location; and to filter and extract from a larger set of weather data, only the data-portions that relate to that particular growing plot. The system may proceed to further correlate between (i) the above data-items, and (ii) topology data (e.g., indicating that this particular growing bed is located on a slanted hill that faces south). The system may further correlate the above-mentioned data-items with sensed or measured data that is particular to that growing bed or plot; for example, sensed temperature, humidity, wetness, dryness, or other sensed or measured data for that particular plot or growing bed; as well as crop properties data that is determined manually by observations and/or automatically via computer vision (e.g., computer vision analysis of an image of a particular plot, which shows that the growing Lemons are green and thus not ripe, or are yellow and thus ripe; or which counts the number of discrete fruit that are visible in an image or per area unit; or that estimated a size of a discrete fruit or plant based on image analysis, such as, by comparing the size of the fruit in the image to a known size of an object that also appears in that image, such as a legend meter). The above-mentioned data-items may further be correlated with lab results or test results, that were performed already with regard to a sample that had been collected from crops of that particular growing bed or plot. The above-mentioned data-items may further be correlated with operational actions and/or agricultural actions that were performed (and logged) with regard to that particular plot; for example, by taking a log of actions of an irrigation controller, and extracting from it the data of irrigation operations that were performed on that particular plot. The above-mentioned data-items may further be correlated with agricultural protocols; for example, a protocol that indicates that a particular type of grapes, that grows on a south-facing hill, which was irrigated at certain time intervals, and which have reached a particular threshold size for average fruit size, should be harvested or collected from the field at a certain timing schedule. The above-mentioned data-items may further be correlated with manufacturing events, actions, processes and/or protocols; for example, indicating that the yield of a particular grape-vine growing bed is generally intended to be utilized for producing a wine of a first type or a wine of a second type, based on the final quality or quantity level of the grapes; and further indicating that if the measured quality level of a sample, that was collected at a particular time-point in-season, is below a pre-defined threshold value, then a procurement process is initiated for purchasing grapes from other sources. In some embodiments, a unique identifier of the growing-bed or plot, together with a season indicator (e.g., “Grapes Bed #62 planted in July 2018”), may be used as a linking tag that is added or appended to the relevant data-items or database records of that particular growing bed or plot; thereby enabling the system to follow, to isolate, and to utilize in an integrative manner (e.g., for analysis and insight generation purposes) the data-items that were collected, imported and converted from multiple different data-sources and domains.

Some embodiments provide a system and method that comprise (or utilize), for example, (a) data collected or obtained from operational data sources across agricultural-based production phases, (b) data collected or obtained from environmental data sources, and (c) mapping or correlating of growing plots to a place on Earth in a manner that integrates operational and environmental/agricultural data items and generates correlations between data items from the different sources.

The system may further comprise or utilize, for example, image data sources, topological data, data from controllers and sensors, BI and analytics processing that is performed on the integrated data, utilization of ML and AI processing, generation of crop performance prediction, generation of crop phenological phases prediction, generation of agricultural product costs, recommendations on agricultural activities, and generation of operational recommendations.

Some embodiments provide an information system for Supply Chain Management, in which information regarding agricultural-origin material in enriched with environmental and agricultural information from current and previous growing seasons. AI analysis is applied to the integrated field-to-market data across the entirety of the supply chain. The system generates, for example, predictions on crop quantity (e.g., yield per acre), crop quality, crop costs, ripening status, crop performance predictions, crop phenological phases predictions, agricultural recommendations, operational recommendations, and sourcing/procurement recommendations.

The Applicants have realized that there are no conventional agriculture-centered/ag-centered satellite imagery providers, and that creating an ag-centered satellite imagery bank may unleash the potential usage of satellite imagery in agriculture applications and systems. Accordingly, some embodiments may utilize a satellite imagery processing engine. Satellite imagery gives global scale view of agricultural fields. As such, it is an important signal to monitor historical and expected crop performance In order to support the platform, a global-scale satellite imagery records may be obtained and maintained. These records may be used both for direct communication with customers and for internal use as input for advanced ML/AI algorithms. An implementation of the satellite imagery processing engine may be constructed based on a survey of available satellite resources, sensors, frequencies monitored, frequency of coverage and historical data availability; using a component or module to identify areas of interest to be monitored for which images are required; using a dedicated satellite imagery storage solution that supports online and offline processing; using integration with a provider API and download of historical archives; using integration with real-time API for periodically downloading updated imagery during the season; by using a stitching and cropping infrastructure that automatically extracts relevant blocks from input images; and/or by process image metadata. The engine may be constructed in a manner that takes into account various challenges or constraints, for example: data storage and management at scale; reliable stitching and cropping to enable ML modeling; extraction of exact field polygons from images.

The Applicants have realized that convention agricultural usage of satellite imagery is very limited, is not automated, and does not quantify the impact of identified issues on final crop performance In contrast, the system of the present invention allows detection and translating observed issues into their strategic impact on the food supply chain of companies using the field's produce; as well as quantifying the economic and environmental impacts of fluctuations and other attributes extracted from satellite imagery across the entire supply chain and on manufacturing operations and manufacturing goals; such as, to determine in advance, based on analysis of such imagery, how change(s) in the field are estimated to impact the manufacturer's ability to meet demand for a certain product, or to have sufficient crop inventory to manufacture a particular line of product, or to perform other manufacturing-related operations. Accordingly, some embodiments may utilize satellite imagery assisted crop performance prediction. Conventional crop performance estimates are traditionally based on historical performance and in-field, in-season measurements. However, in field measurements can be biased as they do not sample the entire field. Satellite imagery analysis can expose and quantify spatial variations in the field, thus facilitating extrapolation of in-field measurements to global field status, which can lead to more accurate crop performance estimates. Implementing this prediction unit may include, for example: (1) Utilizing image processing capabilities to identify and remove field image pixels containing clouds, and correct for cloud shadow effects on observed spectrum. (2) Analyzing correlations between pixel measured metrics and crop performance throughout growth season focusing on yield and key crop metrics (dry matter for potatoes, sugar levels and phonological state in grapes). (3) Evaluating results in mass scale on historical data. (4) Deployment of live pipeline of image download processing and prediction updates. (5) Automatic identification, removal and correction of cloud related image effects (coverage, shadow). (6) Signal correction across images from different satellites, at different resolutions and using different sensors/wavelengths.

The Applicants have realized that field operation data is currently siloed and not used for optimizing fluctuations across the food supply chain, including downstream economic and environmental impact for the food industry. Integration and aggregation of field operation data with other data sources, in accordance with the present invention, may provide another optimization layer for growers as well as food companies. Accordingly, some embodiments may utilize a field operations data processing engine. Field operations are crucial for crop performance. As such, capturing operational data is key for modeling crop performance In conventional systems, data signals are managed using different platforms and solution providers. The fragmentation of data among the different providers (even within the same customer) poses a challenge for using such data coherently. By constructing a unified platform that can interface with the different providers, the system of the present invention obtains a single source of truth covering all the relevant field operation data into one integrated view. This engine may be implemented, for example, by: (1) An automatic scraping engine for historical and live data from various irrigation and fertilization logs across customers; (2) Integrating agronomic operation logs from farm ERP systems; (3) Normalizing irrigation and fertilization data to consistent, comparable metrics across different irrigation system manufacturers; (4) Implementing data quality assurance policy and anomaly detection. The implementation may take into account the following constraints: (1) Development of automatic interface to extract irrigation and fertilization current and historical data from smart irrigation and fertilization controllers of various manufacturers; (2) Building consistent data transformation layer that supports the different data formats available in the market; (3) Filling gaps in data, identifying and mitigating sparse and problematic datasets.

Optionally, the system of the present invention may further enable dynamic creation, modification and implementation of smart, adaptive, field-specific/plot-specific, optimal irrigation and/or fertilization protocols that allow extracting maximal (or increased) crop quantity and quality at every field or plot. Accordingly, some embodiments may utilize irrigation and/or fertilization data to optimize or improve crop quality and/or quantity. Optionally, insights generated by the system may enable to create or modify or adjust irrigation and fertilization best-practices or protocols, to be tailored to individual fields or plots. The system may perform, or may enable to perform, automatic monitoring of historical irrigation and fertilization practices across large numbers of fields, spread across different geographical areas, planted on different types of soil, and being exposed to different weather conditions, along with acquisition of the resulting crop performance in each growth cycle of every field; which in turn may enable the AI platform of the present invention to extract optimal irrigation and/or fertilization and/or cultivation strategies or protocols (or, modifications or adjustments to existing protocols) that are tailored to each field and adapt to real-time weather conditions and/or environmental conditions, or to otherwise modify field inputs and field operations in order to meet manufacturing goals. This may be implemented by, for example: (1) Extracting key irrigation and fertilization features that enhance or decrease crop performance; (2) Determining optimal irrigation and fertilization strategies to quantify optimal values as a function of soil-type, topography and weather conditions; (3) Generating alerts on inefficient field treatment due to varying weather conditions (e.g., unnecessary irrigation in case of rainfall, or insufficient irrigation during heat-waves). The implementation may, for example, combine historical and real-time weather data with irrigation and fertilization data to extract actual environmental conditions in the field (for example, real humidity in the ground based on irrigation and rainfall); and may further identify and extract meaningful irrigation and fertilization features most affecting crop performance, and utilize adaptation schemes to generate field-specific irrigation and fertilization protocols. Other cultivation or growing protocols may be adjusted or modified, similarly to the above discussion with regard to irrigation and/or fertilization.

The Applicants have realized that weather data is fragmented across various platforms and providers. Current available global-scale solutions are inaccurate, target mostly weather forecast use-cases, and cannot be used for reliable agricultural modeling. Constructing high-quality database is important in order to support such applications, and specifically for crop yield and quality predictions. Accordingly, some embodiments may utilize a global historical and live weather data platform. Weather is a major factor affecting crop performance. In order to provide relevant predictions, the platform may have access to accurate, up-to-date and historical data at global scale, both for analysis and to generate predictions. This may depend on obtaining data from a plethora of sources spread across the globe and integrating it into a single, consistent data warehouse. The implementation may include, for example: (1) Automatic scraping of weather data of available sources; (2) Evaluation of available signal channels for each provider/weather station; (3) Historical anomaly detection, and completion of gaps in data; (4) Monitoring of live incoming data, real-time data, steaming data, or other types of data-feeds; (5) Utilization of consistent ingestion processes for obtaining weather data from different providers to handle multiple sources and data formats; (6) In order to overcome large variability in data and quality issues, utilization of filtering and quality assurance metrics to identify faulty weather sensors and data, and adjusting readouts from different providers to a consistent format; (7) Handling of specific challenges associated with unique sensors, channels, or signal types.

The Applicants have realized that at present, there is only scarce hyper-local weather conditions data. Studying systematic deviations in weather conditions across existing weather stations from different sources allows estimation of both historical and live weather parameters previously unavailable. Usage of such data may pave the way to leverage historical crop performance data to better understand the effects of weather conditions on crop performance with much better accuracy than was previously possible. Accordingly, some embodiments may utilize computation of hyper-local historical and live weather conditions based on global weather station data. Weather conditions are monitored at weather-station locations which serve as good proxies for the weather in their surrounding area. However, the correlation between the weather measured at the weather station location and the weather at adjacent locations can be limited and the deviations can be biased due to topography or other hyper-local effects. While some deviations are random, and thus impossible to predict, others are consistent and result from factors that are stationary (such as altitude difference). Such factors can be used to approximate the weather at specific locations that are somewhat away from a given weather station with improved accuracy. The implementation may include, for example: (1) Obtaining historical weather data at locations relevant to fields monitored by the system using the global historical data platform; (2) Correlating weather conditions at adjacent stations to find characteristic weather feature gradients (both time-wise and value-wise); (3) Automatically applying gradient-based factors to yield approximate weather conditions at target fields; (4) Calculating weather gradients between stations accounting for topography and other weather affecting factors (shore related effects, typical high altitude wind conditions, etc.); (5) Differentiating between random, time-related, and value related weather biases and isolate time and values related gradients.

The Applicants have realized that there exists no tool that allows stake-holders to understand the trade-offs between different crop metrics they optimize for, or to suggest growth practices to achieve their goals. The system of the present invention enables an industry-focused recommendation platform for optimizing crop performance for specific food supply chain needs. The availability of high-quality historical data from food companies, alongside environmental data from third party sources, allows the system to operate with unique integration of multiple data sources and computational tools. Accordingly, some embodiments may include units or modules to analyze and explore relationships and tradeoffs between key crop metrics and yield. Each food supply chain aims at optimizing both yield (amount produced per area) and key quality factors (dry matter in potatoes for chips, sugar and acidity levels in grapes for wine production etc.). These factors are inter-related by complex mechanisms resulting from the underlying plant physiology. For example, the total sugar level a vine can produce depends on the area of its leaves as that dictates the amount of photosynthesis it can make, but the weight of the grapes can vary according to the amount of water supplied to the vine, thus a tradeoff exists between weight and sugar level. Researching the tradeoffs as they appear in actual historical growth cycles (both via in-season measurements and via delivery quality monitoring), and mapping the underlying mechanisms governing these trade-offs, enables the construction of live decision support system that empowers growers and food companies, allowing them to make informed decisions about their possible crop performance goals, and guide them in obtaining optimal crops according to their needs. The implementation may include, for example: (1) identification of interplay between key crop metrics factor in existing historical data; (2) Identification of key drivers for different crop metric values, which may require high resolution (temporal/special) data (e.g., detailed historical irrigation/fertilization data, high quality agrotechnical records); (3) Deducing crop behavior in previously met conditions or even in previously unmet conditions (to a degree of certainty).

Furthermore, some embodiments may identify key crop metrics that affect the economics of the food supply chain for relevant crops. For example, a literature survey may be performed to extract expected physiological constraints and inter-relationships between key metrics, and to devise a quantitative model on their interplay. Then, identification of key drivers for the values of the different metrics may be performed through analysis of historical crop data. Additionally, a quantitative recommendation system may allow growers and food companies to define their target crop performance in the possible or feasible space, given their growth environment, and guides them in best practices to achieve their target goals. The implementation may include, for example: identification of interplay between key crop metrics factor in existing historical data; Identification of key drivers for different crop metric values, which may require high resolution (temporal/special) data from multiple sources (e.g., detailed historical irrigation/fertilization data, high quality agrotechnical records); deducing crop behavior in previously met conditions and even in previously unmet conditions.

The Applicants have realized that there is no tool at present for food manufacturers that integrates market, manufacturing and supply chain data to allow Just-in-Time planning of the supply chain while factoring in real-time and predictive information of raw ingredients. These processes involve gathering information from multiple stakeholders without using advanced analytics that identify and quantify global market trends and extract actionable business insights according to ROI model at real-time. Accordingly, some embodiments may include a Just-In-Time (JIT) planning optimization module, which integrates expected crop, delivery ETA, storage status, and manufacturing requirements. The implementation may utilize, for example: (1) a harvest prioritization module based on crop prediction (ripeness, volume, and quality), storage capacity at the manufacturing facility, value of crop, and manufacturing plan; (2) a pattern recognition module to identify cost of variance and profitability drivers across the supply chain based on historical procurement transactions; (3) a module to compute impact on sustainability and revenue performance year over year (or season over season) by supply chain and market analysis.

The Applicants have realized that currently, food and beverage manufacturers rely on public data sources which aggregate high-level information sources on agriculture productivity on the crop/state/region level. This information is not personalized for the specific supply chain needs of the customers, and specifically it does not integrate historical transactions with global forecasts and real-time predictions on agriculture produce. In addition, many companies buy agriculture produce on the spot market in addition to contracted growers (e.g. sourcing from both estate vineyards and bulk-wine buys), and there is currently no integrated and predictive view of all sourcing channels. Furthermore, no convention system is correlating crop performance and cost using a combination of private food company data and publicly available data. Accordingly, some embodiments may include a model ROI and business decision logic for food and beverage companies. The Applicants have realized that procurement of agriculture produce is a complex task that needs to take into account production goals (market demand), storage, manufacturing, as well as crop predictions on quality, quantity, timing and cost. The nature of agriculture produce generates high level of uncertainty, which result in sub-optimal buy/sell decisions, that in turn lead to lost profit and food waste. The system of the present invention utilizes crop prediction that covers quality, quantity and timing; and further helps customers who are interested in how these dimensions impact the overall input costs and/or the overall ROI. The implementation may include, for example: (1) Utilization of public data providers and APIs which provide commodity cost data; (2) Integrating public data with customer's private data of historical procurement and import transactions; (3) Algorithms for anomaly detection and pattern recognition in agriculture produce prices; (4) Developing a time-based cost prediction model; (5) Implementing real-time commodity cost predictions report as part of the platform's dashboard.

The Applicants have realized that plant disease and pest monitoring and control has been a long-standing challenge for growers and food companies. Nevertheless, quantitative assessment of impact of crop health on field output, based on the specific details of the field, season, crop and disease, is still done manually. By integrating historical disease and crop data, the platform of the present invention enables to automatically and quantitatively assess the impact of crop disease and pest on the end-of-season field output early in the season, allowing food companies to logistically prepare for the risk and manage it more effectively. Accordingly, some embodiments may utilize a quantitative crop disease impact model. Diseases and pests significantly impact crop yield quality worldwide. Consistent monitoring of crop health through third party platforms may enable the system to evaluate crop health in real time, and to notify customers on the expected impact they will suffer in cases of disease outbreak, as well as alert them on suggested mitigation strategies. The implementation may include, for example: (1) Obtaining data from crop health monitoring and prediction providers in target industries; (2) Creating an integration platform with key providers for historical and live data feed; (3) Estimating or determining impact of crop health status on key crop metrics using historical customers' data; (4) Integrating crop health metrics and predicted impact with the system's other prediction models; (5) Crop disease evaluation, which is often done manually and results in human-written reports, may require OCR/NLP processing for extraction of machine-processible crop health data; (6) Crop health monitoring may be spread across different contractors and providers, potentially using different data collection formats, which the system may consolidate or re-format or normalize or convert for co-utilization of data from different sources; (7) Monitored providers, food companies, and growers might not hold complete historical record of monitoring reports, and monitoring providers may have changed historically, and such gaps or incomplete records may be taken into account.

Some embodiments may include a method comprising: (a) collecting agricultural data from multiple sources relating to multiple growing-plots of crops; (b) collecting environmental data relating to said multiple growing-plots; (c) collecting manufacturing and operational data with regard to intended utilization of said crops at a manufacturing facility; (d) identifying a particular growing-plot; (e) correlating among (i) agricultural data related to said particular growing-plot, and (ii) environmental data related to said particular growing-plot, and (iii) operational data related to intended utilization of crops from said particular growing-plot, and (iv) manufacturing data and marketing data related to intended utilization of crops from said particular growing plot; (f) analyzing correlated data of step (e), and generating at least one of: (I) an agricultural action recommendation to be performed at said particular growing-plot, (II) an operational action recommendation to be performed at said manufacturing facility.

In some embodiments, the method comprises: analyzing correlated data of step (e), and generating a prediction of one or more attributes of crops of said particular growing-plot.

In some embodiments, the method comprises: analyzing correlated data of step (e), and generating a prediction of phenological status of crops of said particular growing-plot.

In some embodiments, the method comprises: the correlating of step (e) comprises: extracting a particular set of environmental data-items, that pertain to a location of said particular growing-plot, and that pertain to a particular growing-season; associating between (I) said particular set of environmental data-items, and (II) one or more non-environmental data-items that relate to said particular growing-plot.

In some embodiments, the correlating of step (e) comprises: extracting a particular set of weather data-items, that pertain to a location of said particular growing-plot, and that pertain to a particular growing-season; associating between (I) said particular set of weather data-items, and (II) one or more non-environmental data-items that relate to said particular growing-plot.

In some embodiments, the correlating of step (e) comprises: extracting a particular set of irrigation-operations data-items, that pertain to a location of said particular growing-plot, and that pertain to a particular growing-season; associating between (I) said particular set of irrigation-operations data-items, and (II) one or more crop-attributes of said particular growing-plot.

In some embodiments, the correlating of step (e) comprises: extracting a particular set of fertilization-operations data-items, that pertain to a location of said particular growing-plot, and that pertain to a particular growing-season; associating between (I) said particular set of fertilization-operations data-items, and (II) one or more crop-attributes of said particular growing-plot.

In some embodiments, the correlating of step (e) comprises: determining geo-spatial topology attributes of said particular growing-plot; associating between (I) geo-spatial topology attributes of said particular growing-plot, and (II) one or more crop-attributes of said particular growing-plot.

In some embodiments, the correlating of step (e) comprises: extracting a particular set of ambient temperature data-items, that pertain to a location of said particular growing-plot, and that pertain to a particular growing-season; associating between (I) said particular set of ambient temperature data-items, and (II) one or more non-environmental data-items that relate to said particular growing-plot.

In some embodiments, the analyzing of step (f) comprises: executing a Machine Learning (ML) or an Artificial Intelligence (AI) analysis on the correlated data of step (e), and generating a proposal to perform an agricultural action on said particular growing-bed.

In some embodiments, the analyzing of step (f) comprises: executing a Machine Learning (ML) or an Artificial Intelligence (AI) analysis on the correlated data of step (e), and generating a proposal to perform an operational action in said manufacturing facility based on data related to said particular growing-bed.

In some embodiments, the analyzing of step (f) comprises: executing a Machine Learning (ML) or an Artificial Intelligence (AI) analysis on the correlated data of step (e), and generating a proposal to perform an inventory purchase action in said manufacturing facility based on data related to said particular growing-bed.

In some embodiments, the analyzing of step (f) comprises: executing a Machine Learning (ML) or an Artificial Intelligence (AI) analysis on the correlated data of step (e), and generating a determination that crops that will be subsequently harvested from said particular growing-bed are suitable for a first particular manufacturing process in said manufacturing facility and are non-suitable for a second particular manufacturing process in said manufacturing facility.

In some embodiments, the analyzing of step (f) comprises: executing a computer vision process on one or more images of said particular growing-plot, and identifying one or more crop-attributes of crops being grown in said particular growing-plot; generating a recommendation for an operational action, to be performed in said manufacturing facility, based on said crop-attributes that were identified for crops being grown in said particular growing-plot.

In some embodiments, the analyzing of step (f) comprises: (A) performing computer vision analysis of current images of current crops that currently grow in said particular growing-plot; (B) performing computer vision analysis of past images of past crops that were previously grown in said particular growing-plot; (C) comparing between analysis results of step (A) and analysis results of step (B), and based on said comparing, and further based on past crop-attributes that were measured on said past crops, determining one or more crop-attributes of said current crops that currently grow in said particular growing-plot.

In some embodiments, the analyzing of step (f) comprises: (A) performing weather analysis of current-season weather conditions with regard to a current growing-season of said particular growing-plot; (B) performing weather analysis of past-season weather conditions with regard to a past growing-season of said particular growing-plot; (C) comparing between analysis results of step (A) and analysis results of step (B), and based on said comparing, and further based on past crop-attributes that were measured for crops of said past growing-season, determining one or more crop-attributes of current crops that currently grow in said particular growing-plot.

In some embodiments, the analyzing of step (f) comprises: generating a proposal for operational action, to be performed at said manufacturing facility, based on analysis of at least: (I) current growing-season temperature-data of said particular growing-plot, and (II) current growing-season precipitation-conditions in said particular growing-plot, and (III) geo-spatial slanting topology of said particular growing-plot.

In some embodiments, the analyzing of step (f) comprises: generating a proposal for operational action, to be performed at said manufacturing facility, based on analysis of at least: (I) current growing-season temperature-data of said particular growing-plot, and (II) current growing-season precipitation-data in said particular growing-plot, and (III) geo-spatial slanting topology of said particular growing-plot.

In some embodiments, the analyzing of step (f) comprises: generating a proposal for operational action, to be performed at said manufacturing facility, based on analysis of at least: (I) current growing-season irrigation-events performed at said particular growing-plot, and (II) current growing-season fertilization-events performed at said particular growing-plot, and (III) current growing-season cultivation-operations performed at said particular growing-plot.

In some embodiments, the method comprises: based on analysis of correlated data, generating a prediction of crop-attributes for crops that are currently growing in said particular growing-plot.

In some embodiments, the method comprises: based on analysis of correlated data, generating a prediction of a timing attribute of a future phenological phase for crops that are currently growing in said particular growing-plot.

In some embodiments, the method comprises: storing in a data repository, digital information regarding agricultural-origin materials of multiple different particular growing-plots; wherein the storing comprises: linking between (A) information regarding agricultural-origin materials of each discrete growing-plot, and a set of data-items which comprises: (B1) current-season environmental conditions in said discrete growing-plot, (B2) past-season environmental conditions in said discrete growing-plot, (B3) agricultural operations performed during current growing-season in said discrete growing-plot, (B4) agricultural operations performed during a past growing-season in said discrete growing plot.

In some embodiments, the method comprises: determining which operational action to perform in said manufacturing facility, from a pool of multiple operational actions, based on an analysis of: (i) current-season environmental conditions of said particular growing-plot, (ii) past-season environmental conditions of said particular growing-plot, (iii) current-season agricultural operations performed in said particular growing-plot, (iv) past-season agricultural operations performed in said particular growing-plot.

In some embodiments, step (f) comprises generating at least one recommendation selected from the group consisting of: an in-season recommendation to purchase agricultural crops, an in-season recommendation to sell agricultural crops.

In some embodiments, the method further comprises: (A) automatically extracting from an Enterprise Resource Planning (ERP) system historical data about historical delivery and procurement of crops from said particular growing-plot to said manufacturing facility; (B) automatically correlating between (i) data extracted in step (A), and current growth profile and agricultural crop performance of crops in said particular growing-plot; (C) based on steps (A) and (B), automatically generating at least one notification from the group consisting of: (I) a recommendation to perform a particular agricultural operation at said particular growing-plot, (II) a recommendation to perform a particular manufacturing-related operation at said manufacturing facility, (III) a notification about a detected inefficiency or a detected risk related to said particular growing-plot.

Some embodiments may comprise a system comprising at least a hardware processor and/or a memory unit and/or program code, able to perform a method as described above; as well as non-transitory storage medium having stored thereon instructions or program code that, when executed by a processor or a machine, cause such processor or machine to perform a method as described above.

Some embodiments of the present invention may be implemented by utilizing any suitable combination of hardware components and/or software modules; as well as other suitable units or sub-units, processors, controllers, DSPs, FPGAs, CPUs, Integrated Circuits, output units, input units, memory units, long-term or short-term storage units, buffers, power source(s), wired links, wireless communication links, transceivers, Operating System(s), software applications, drivers, or the like.

Any of the above-mentioned devices, units and/or systems, may be implemented by using suitable hardware components and/or software components; for example, a processor, a processing core, a Central Processing Unit (CPU), a Digital Signal Processor (DSP), an Integrated Circuit (IC), and Application-Specific Integrated Circuit (ASIC), a memory unit (e.g., Random Access Memory (RAM), Flash memory), a storage unit (e.g., hard disk drive (HDD), solid state drive (SDD), Flash memory), an input unit (keyboard, keypad, mouse, joystick, touch-pad, touch-screen, microphone), an output unit (screen, touch-screen, monitor, audio speakers), a power source (battery, rechargeable battery, power cell, connection to electric outlet), a wireless transceiver, a cellular transceiver, a wired or wireless modem, a network interface card or element, an accelerometer, a gyroscope, a compass unit, a Global Positioning System (GPS) unit, an Operating System (OS), drivers, applications, and/or other suitable components.

In some implementations, calculations, operations and/or determinations may be performed locally within a single device, or may be performed by or across multiple devices, or may be performed partially locally and partially remotely (e.g., at a remote component or a co-located component) by optionally utilizing a communication channel to exchange raw data and/or processed data and/or processing results.

Although portions of the discussion herein relate, for demonstrative purposes, to wired links and/or wired communications, some implementations are not limited in this regard, but rather, may utilize wired communication and/or wireless communication; may include one or more wired and/or wireless links; may utilize one or more components of wired communication and/or wireless communication; and/or may utilize one or more methods or protocols or standards of wireless communication.

Some implementations may utilize a special-purpose machine or a specific-purpose device that is not a generic computer, or may use a non-generic computer or a non-general computer or machine. Such system or device may utilize or may comprise one or more components or units or modules that are not part of a “generic computer” and that are not part of a “general purpose computer”, for example, cellular transceiver, cellular transmitter, cellular receiver, GPS unit, location-determining unit, accelerometer(s), gyroscope(s), device-orientation detectors or sensors, device-positioning detectors or sensors, or the like.

Some implementations may utilize an automated method or automated process, or a machine-implemented method or process, or as a semi-automated or partially-automated method or process, or as a set of steps or operations which may be executed or performed by a computer or machine or system or other device.

Some implementations may utilize code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL), Register-Transfer Level (RTL), BASIC, Visual BASIC, Matlab, Pascal, HTML, HTML5, CSS, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Functions, operations, components and/or features described herein with reference to one or more implementations, may be combined with, or may be utilized in combination with, one or more other functions, operations, components and/or features described herein with reference to one or more other implementations. Some embodiments may comprise any possible or suitable combinations, re-arrangements, assembly, re-assembly, or other utilization of some or all of the modules or functions or components or units that are described herein, even if they are discussed in different locations or different chapters of the above discussion, or even if they are shown across different drawings or multiple drawings.

While certain features of some demonstrative embodiments have been illustrated and described herein, various modifications, substitutions, changes, and equivalents may occur to those skilled in the art. Accordingly, the claims are intended to cover all such modifications, substitutions, changes, and equivalents.

1. A method comprising:
(a) collecting agricultural data from multiple sources relating to multiple growing-plots of crops;
(b) collecting environmental data relating to said multiple growing-plots;
(c) collecting manufacturing and operational data with regard to intended utilization of said crops at a manufacturing facility;
(d) identifying a particular growing-plot;
(e) correlating among (i) agricultural data related to said particular growing-plot, and (ii) environmental data related to said particular growing-plot, and (iii) operational data related to intended utilization of crops from said particular growing-plot, and (iv) manufacturing data and marketing data related to intended utilization of crops from said particular growing plot;
(f) analyzing correlated data of step (e), and generating at least one of: (I) an agricultural action recommendation to be performed at said particular growing-plot, (II) an operational action recommendation to be performed at said manufacturing facility.

2. The method of claim 1, further comprising:
analyzing correlated data of step (e), and generating a prediction of one or more attributes of crops of said particular growing-plot.

3. The method of claim 1, further comprising:
analyzing correlated data of step (e), and generating a prediction of phenological status of crops of said particular growing-plot.

4. The method of claim 1,
wherein the correlating of step (e) comprises:
extracting a particular set of environmental data-items, that pertain to a location of said particular growing-plot, and that pertain to a particular growing-season;
associating between (I) said particular set of environmental data-items, and (II) one or more non-environmental data-items that relate to said particular growing-plot.

5. The method of claim 1,
wherein the correlating of step (e) comprises:
extracting a particular set of weather data-items, that pertain to a location of said particular growing-plot, and that pertain to a particular growing-season;
associating between (I) said particular set of weather data-items, and (II) one or more non-environmental data-items that relate to said particular growing-plot.

6. The method of claim 1,
wherein the correlating of step (e) comprises:
extracting a particular set of irrigation-operations data-items, that pertain to a location of said particular growing-plot, and that pertain to a particular growing-season;
associating between (I) said particular set of irrigation-operations data-items, and (II) one or more crop-attributes of said particular growing-plot.

7. The method of claim 1,
wherein the correlating of step (e) comprises:
extracting a particular set of fertilization-operations data-items, that pertain to a location of said particular growing-plot, and that pertain to a particular growing-season;
associating between (I) said particular set of fertilization-operations data-items, and (II) one or more crop-attributes of said particular growing-plot.

8. The method of claim 1,
wherein the correlating of step (e) comprises:
determining geo-spatial topology attributes of said particular growing-plot;
associating between (I) geo-spatial topology attributes of said particular growing-plot, and (II) one or more crop-attributes of said particular growing-plot.

9. The method of claim 1,
wherein the correlating of step (e) comprises:
extracting a particular set of ambient temperature data-items, that pertain to a location of said particular growing-plot, and that pertain to a particular growing-season;
associating between (I) said particular set of ambient temperature data-items, and (II) one or more non-environmental data-items that relate to said particular growing-plot.

10. The method of claim 1,
wherein the analyzing of step (f) comprises:
executing a Machine Learning (ML) or an Artificial Intelligence (AI) analysis on the correlated data of step (e), and generating a proposal to perform an agricultural action on said particular growing-bed.

11. The method of claim 1,
wherein the analyzing of step (f) comprises:
executing a Machine Learning (ML) or an Artificial Intelligence (AI) analysis on the correlated data of step (e), and generating a proposal to perform an operational action in said manufacturing facility based on data related to said particular growing-bed.

12. The method of claim 1,
wherein the analyzing of step (f) comprises:
executing a Machine Learning (ML) or an Artificial Intelligence (AI) analysis on the correlated data of step (e), and generating a proposal to perform an inventory purchase action in said manufacturing facility based on data related to said particular growing-bed.

13. The method of claim 1,
wherein the analyzing of step (f) comprises:
executing a Machine Learning (ML) or an Artificial Intelligence (AI) analysis on the correlated data of step (e), and generating a determination that crops that will be subsequently harvested from said particular growing-bed are suitable for a first particular manufacturing process in said manufacturing facility and are non-suitable for a second particular manufacturing process in said manufacturing facility.

14. The method of claim 1,
wherein the analyzing of step (f) comprises:
executing a computer vision process on one or more images of said particular growing-plot, and identifying one or more crop-attributes of crops being grown in said particular growing-plot;
generating a recommendation for an operational action, to be performed in said manufacturing facility, based on said crop-attributes that were identified for crops being grown in said particular growing-plot.

15. The method of claim 1,
wherein the analyzing of step (f) comprises:
(A) performing computer vision analysis of current images of current crops that currently grow in said particular growing-plot;
(B) performing computer vision analysis of past images of past crops that were previously grown in said particular growing-plot;
(C) comparing between analysis results of step (A) and analysis results of step (B), and based on said comparing, and further based on past crop-attributes that were measured on said past crops, determining one or more crop-attributes of said current crops that currently grow in said particular growing-plot.

16. The method of claim 1,
wherein the analyzing of step (f) comprises:
(A) performing weather analysis of current-season weather conditions with regard to a current growing-season of said particular growing-plot;
(B) performing weather analysis of past-season weather conditions with regard to a past growing-season of said particular growing-plot;
(C) comparing between analysis results of step (A) and analysis results of step (B), and based on said comparing, and further based on past crop-attributes that were measured for crops of said past growing-season, determining one or more crop-attributes of current crops that currently grow in said particular growing-plot.

17. The method of claim 1,
wherein the analyzing of step (f) comprises:
generating a proposal for operational action, to be performed at said manufacturing facility, based on analysis of at least: (I) current growing-season temperature-data of said particular growing-plot, and (II) current growing-season precipitation-conditions in said particular growing-plot, and (III) geo-spatial slanting topology of said particular growing-plot.

18. The method of claim 1,
wherein the analyzing of step (f) comprises:
generating a proposal for operational action, to be performed at said manufacturing facility, based on analysis of at least: (I) current growing-season temperature-data of said particular growing-plot, and (II) current growing-season precipitation-data in said particular growing-plot, and (III) geo-spatial slanting topology of said particular growing-plot.

19. The method of claim 1,
wherein the analyzing of step (f) comprises:
generating a proposal for operational action, to be performed at said manufacturing facility, based on analysis of at least: (I) current growing-season irrigation-events performed at said particular growing-plot, and (II) current growing-season fertilization-events performed at said particular growing-plot, and (III) current growing-season cultivation-operations performed at said particular growing-plot.

20. The method of claim 1, comprising:
based on analysis of correlated data, generating a prediction of crop-attributes for crops that are currently growing in said particular growing-plot.

21. The method of claim 1, comprising:
based on analysis of correlated data, generating a prediction of a timing attribute of a future phenological phase for crops that are currently growing in said particular growing-plot.

22. The method of claim 1, comprising:
storing in a data repository, digital information regarding agricultural-origin materials of multiple different particular growing-plots;
wherein the storing comprises:
linking between (A) information regarding agricultural-origin materials of each discrete growing-plot, and a set of data-items which comprises: (B1) current-season environmental conditions in said discrete growing-plot, (B2) past-season environmental conditions in said discrete growing-plot, (B3) agricultural operations performed during current growing-season in said discrete growing-plot, (B4) agricultural operations performed during a past growing-season in said discrete growing plot.

23. The method of claim 1, comprising:
determining which operational action to perform in said manufacturing facility, from a pool of multiple operational actions, based on an analysis of: (i) current-season environmental conditions of said particular growing-plot, (ii) past-season environmental conditions of said particular growing-plot, (iii) current-season agricultural operations performed in said particular growing-plot, (iv) past-season agricultural operations performed in said particular growing-plot.

24. The method of claim 1,
wherein step (f) comprises generating at least one recommendation selected from the group consisting of: an in-season recommendation to purchase agricultural crops, an in-season recommendation to sell agricultural crops.

25. The method of claim 1, further comprising:
(A) automatically extracting from an Enterprise Resource Planning (ERP) system historical data about historical delivery and procurement of crops from said particular growing-plot to said manufacturing facility;
(B) automatically correlating between (i) data extracted in step (A), and current growth profile and agricultural crop performance of crops in said particular growing-plot;
(C) based on steps (A) and (B), automatically generating at least one notification from the group consisting of:
(I) a recommendation to perform a particular agricultural operation at said particular growing-plot,
(II) a recommendation to perform a particular manufacturing-related operation at said manufacturing facility,
(III) a notification about a detected inefficiency or a detected risk related to said particular growing-plot.
